(19) United States
(12) Patent Application Publication
(10) Pub. No.: US 2022/0011206 A1
(43) Pub. Date: Jan. 13, 2022

(54) STRENGTH MEASURING APPARATUS AND STRENGTH MEASURING METHOD

(71) Applicant: SINTOKOGIO, LTD., Nagoya-shi (JP)

(72) Inventors: Takato ISHII, Nagoya-shi (JP); Hiroki MATSUOKA, Nagoya-shi (JP); Takehiro SUGINO, Nagoya-shi (JP)

(73) Assignee: SINTOKOGIO, LTD., Nagoya-shi (JP)

(21) Appl. No.: 17/365,157

(22) Filed: Jul. 1, 2021

(30) Foreign Application Priority Data
Jul. 9, 2020 (JP) 2020-118431

(51) Int. Cl. G01N 3/08; G01N 3/40; B25J 9/00; B25J 13/08; B65G 43/00; G01N 35/00

(52) U.S. Cl. CPC G01N 3/08; G01N 3/40; B25J 9/0093; B25J 13/088; B65G 2203/0233; G01N 35/0099; G01N 2203/0019; G01N 2203/0076; G01N 2203/0206; B65G 43/00

(57) ABSTRACT

The strength measuring apparatus includes: a strength measuring instrument measuring the strength of the mold on the basis of a reaction force received from the mold; a moving unit moving the strength measuring instrument; a distance sensor measuring a distance to an object on the conveyance line; and a control unit controlling the moving unit, wherein the control unit determines a measurement position of the strength measuring instrument in a horizontal direction perpendicular to a conveyance direction of the conveyance line on the basis of the distance detected by the distance sensor and controls the moving unit to move the strength measuring instrument to a position above the measurement position.

### CROSS-REFERENCE TO RELATED APPLICATION

This application is based on Japanese Patent Application No. 2020-118431 filed with Japan Patent Office on Jul. 9, 2020, the entire contents of which are hereby incorporated by reference.

### TECHNICAL FIELD

The present disclosure relates to a strength measuring apparatus and a strength measuring method.

### BACKGROUND

Japanese Unexamined Patent Publication No. H7-232235 discloses an apparatus which measures the strength of molds continuously conveyed. The apparatus includes a force sensor which measures the strength of molds and moving means which moves the force sensor. When a mold is carried into the apparatus, the force sensor is moved by the moving means to a position above a position where the strength of the mold should be measured and then lowered to a predetermined height. The force sensor comes into contact with the surface of the mold and measures the strength of the surface of the mold.

### SUMMARY

The size of the mold may be changed according to a product to be manufactured. Typically, the position where the strength of the mold should be measured is set in a part close to the outer edge of the mold so as not to affect the quality of the product. Thus, it is necessary to change the position where the strength of the mold should be measured according to the size of the mold. The present disclosure provides a technique capable of measuring the strength of a mold at an appropriate position regardless of the size of the mold.

A strength measuring apparatus according to one aspect of the present disclosure is provided on a conveyance line conveying a mold and measures a strength of the mold on the conveyance line. The apparatus includes: a strength measuring instrument measuring the strength of the mold on the basis of a reaction force received from the mold; a moving unit moving the strength measuring instrument; a distance sensor measuring a distance to an object on the conveyance line; and a control unit controlling the moving unit. The control unit determines a measurement position of the strength measuring instrument in a horizontal direction perpendicular to a conveyance direction of the conveyance line on the basis of the distance detected by the distance sensor and controls the moving unit to move the strength measuring instrument to a position above the measurement position.

In the strength measuring apparatus, the distance to the object on the conveyance line is measured by the distance sensor, and the measurement position of the strength measuring instrument in the horizontal direction perpendicular to the conveyance direction of the conveyance line is determined by the control unit on the basis of the measured distance. The strength measuring instrument is moved by the moving unit to the position above the measurement position. Since the measurement position is determined taking into consideration the distance to the object on the conveyance line in this manner, the strength measuring apparatus can measure the strength of the mold at an appropriate position regardless of the size of the mold.

In one embodiment, the distance sensor may be disposed so as to measure a distance in a height direction. The strength measuring apparatus may further include a sensor moving unit moving the distance sensor in the horizontal direction perpendicular to the conveyance line. The control unit may recognize an outer edge position of the object on the conveyance line on the basis of a change in the distance detected by the distance sensor and determine the measurement position on the basis of the outer edge position. In this case, the distance sensor measures the distance in the height direction while moving in the horizontal direction perpendicular to the conveyance line. Thus, the distance in the height direction can be obtained at each position in the direction perpendicular to the conveyance line. For example, a position where the distance along the height direction largely changes is regarded as the outer edge position of the object on the conveyance line, and the measurement position is determined on the basis of the outer edge position. In this manner, the strength measuring apparatus can measure the strength of the mold at an appropriate position on the basis of the change in the distance in the height direction.

In one embodiment, the distance sensor may be disposed so as to measure a distance in a height direction. The moving unit may move the distance sensor together with the strength measuring instrument in the horizontal direction perpendicular to the conveyance line. The control unit may recognize an outer edge position of the object on the conveyance line on the basis of a change in the distance detected by the distance sensor and determine the measurement position on the basis of the outer edge position. In this case, the strength measuring apparatus can measure the strength of the mold at an appropriate position on the basis of the change in the distance in the height direction without a sensor moving unit which moves the sensor alone.

In one embodiment, the distance sensor may be disposed so as to measure a distance in the horizontal direction perpendicular to the conveyance direction of the conveyance line. In this case, the control unit can recognize the outer edge position of the object on the conveyance line on the basis of the distance detected by the distance sensor and determine the measurement position on the basis of the outer edge position.

In one embodiment, the strength measuring apparatus may further include a positioning unit bringing the mold on the conveyance line to a standstill at a predetermined operation position. In this case, the strength measuring apparatus can measure the strength of the mold after the positioning unit brings the mold to a standstill at the predetermined operation position. Thus, the strength measuring apparatus can reduce a measurement error caused by misalignment of the mold.

In one embodiment, the control unit may determine whether a predetermined step relating to the mold is performable on the basis of the strength of the mold measured by the strength measuring instrument. In this case, for example, the strength measuring apparatus can avoid a case where the predetermined step is performed on the mold whose strength is not sufficient and a case where a waiting time for hardening is set for the mold whose strength is already sufficient.

In one embodiment, the predetermined step may be a pattern removing step. The control unit may output a pattern removal enabling signal when it is determined that the pattern removing step relating to the mold is performable. The strength measuring instrument may remeasure the strength of the mold after an elapse of a predetermined time when it is determined that the pattern removing step relating to the mold is not performable. In this case, the strength measuring apparatus can determine whether the pattern removing step is performable on the basis of the strength of the mold and remeasure the strength of the mold on which the pattern removing step is not performable after the waiting time for hardening.

In one embodiment, the strength measuring apparatus may include a storage unit associating the strength of the mold measured by the strength measuring instrument with the mold.

A strength measuring method according to another aspect of the present disclosure is a method for measuring a strength of a mold on a conveyance line using a strength measuring instrument, the method including: a step of measuring, using a distance sensor, a distance to an object on the conveyance line; a step of determining a measurement position of the strength measuring instrument in a horizontal direction perpendicular to a conveyance direction of the conveyance line on the basis of the distance detected by the distance sensor and moving the strength measuring instrument to a position above the measurement position; and a step of measuring, using the strength measuring instrument, the strength of the mold at the measurement position.

In the strength measuring method, the distance to the object on the conveyance line is measured by the distance sensor. The measurement position of the strength measuring instrument in the horizontal direction perpendicular to the conveyance direction of the conveyance line is determined on the basis of the distance detected by the distance sensor. The strength measuring instrument is moved to the position above the measurement position. The strength of the mold at the measurement position is measured by the strength measuring instrument. Since the measurement position is determined taking into consideration the distance to the object on the conveyance line in this manner, the strength measuring method can measure the strength of the mold at an appropriate position regardless of the size of the mold.

According to the technique of the present disclosure, it is possible to measure the strength of a mold at an appropriate position regardless of the size of the mold.

### BRIEF DESCRIPTION OF THE DRAWINGS

FIG. 1 is a configuration diagram illustrating an example of a part of a casting system including a strength measuring apparatus according to an embodiment;

FIG. 2 is a top view illustrating an example of the strength measuring apparatus according to the embodiment;

FIG. 3 is a sectional view illustrating an example of the strength measuring apparatus according to the embodiment;

FIG. 4 is a flowchart illustrating an example of an operation of the strength measuring apparatus;

FIG. 5 is a sectional view illustrating an example of a strength measuring apparatus further including a robot which moves a distance sensor in a horizontal direction;

FIG. 6 is a sectional view illustrating an example of a strength measuring apparatus further including a robot which moves a distance sensor in a vertical direction;

FIG. 7 is a sectional view illustrating an example of a strength measuring apparatus including a plurality of horizontal-direction distance sensors;

FIG. 8 is a sectional view illustrating an example of a strength measuring apparatus including a vertical-direction distance sensor and a horizontal-direction distance sensor;

FIG. 9 is a sectional view illustrating an example of a strength measuring apparatus including one horizontal-direction distance sensor;

FIG. 10 is a top view of a strength measuring apparatus including another positioning unit;

FIG. 11 is a configuration diagram illustrating another example of a part of the casting system including the strength measuring apparatus; and

FIG. 12 is a configuration diagram illustrating an example of a conveyance line 3 which annularly conveys molds M.

### DETAILED DESCRIPTION

Hereinbelow, an embodiment of the present disclosure will be described with reference to the drawings. Note that, in the following description, identical reference signs designate identical or corresponding elements to omit redundant description. The dimensional ratio in the drawings does not necessarily coincide with an actual ratio. The “up”, “down”, “left” and “right” are based on an illustrated state and used for convenience sake.

Example of Casting System

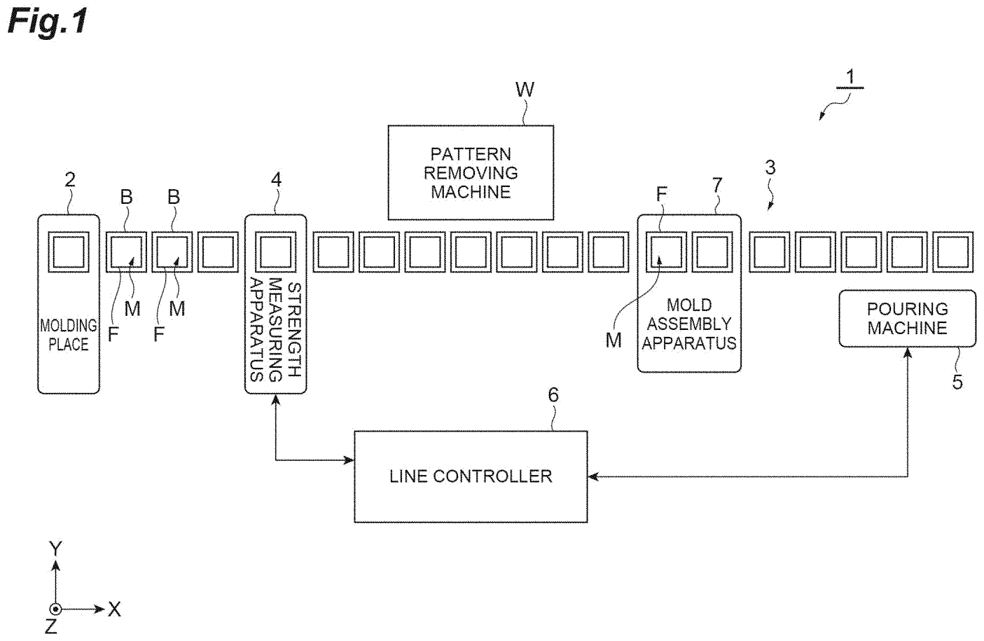

FIG. 1 is a configuration diagram schematically illustrating an example of a part of a casting system including a strength measuring apparatus according to an embodiment. A casting system 1 (a part of the casting system) illustrated in FIG. 1 is a system for manufacturing casts using molds M which are self-hardening molds. As illustrated in FIG. 1, the casting system 1 includes a molding place 2, a conveyance line 3, a strength measuring apparatus 4, a pouring machine 5, a line controller 6, and a mold assembly apparatus 7. In the drawings, an X direction and a Y direction correspond to a horizontal direction, and a Z direction corresponds to a vertical direction. The X, Y, and Z directions are axial directions perpendicular to each other in a rectangular coordinate system in a three-dimensional space.

In the molding place 2, mixed sand is charged into a molding flask F placed on a molding board B to manufacture the mold M. The mold M is, for example, a cope or a drag. The mixed sand contains a chemical solution (resin, a hardening agent) and casting sand, and is hardened with time. The mold M manufactured in the molding place 2 is fed to the conveyance line 3.

The conveyance line 3 is a facility which conveys the mold M from upstream to downstream. The conveyance line 3 receives the mold M from the molding place 2 and conveys the mold M placed on the molding board B to the pouring machine 5 located on the downstream side. The conveyance line 3 may include, for example, a driving roller, a roller conveyor, a rail, a carriage which travels on the rail, a pusher device which is disposed at the molding place 2 side, and a cushion device which is disposed at the pouring machine 5 side. In a case where the conveyance line 3 includes a driving roller, the molding board B is provided with a roller traveling surface. The conveyance line 3 linearly extends from the molding place 2 to the pouring machine 5. The conveyance line 3 may extend not linearly, but, for example, in a step-like manner. The conveyance line 3 may extend in a single stroke manner between the molding place 2 and the pouring machine 5. The conveyance line 3 sequentially conveys the molds M placed on a plurality of molding boards B, which are arranged at regular intervals on the driving roller, from the molding place 2 to the pouring machine 5. The conveyance line 3 is intermittently driven and conveys the molds M by a predetermined number of flasks at each drive. The predetermined number of flasks may be one flask or may be a plurality of flasks. The conveyance line 3 is communicably connected to the line controller 6. When receiving a flask feeding signal from the line controller 6, the conveyance line 3 conveys the plurality of molds M by the predetermined number of flasks. Upon completion of the conveyance of the predetermined number of flasks, the conveyance line 3 transmits a flask feeding completion signal to the line controller 6. The conveyance line 3 may transmit the flask feeding completion signal to the line controller 6 when positioning of the conveyed molds M is completed.

The strength measuring apparatus 4 is provided on the conveyance line 3 and performs measurement of the strength on the mold M on the conveyance line 3. The strength measuring apparatus 4 can be communicably connected to the line controller 6. The strength measuring apparatus 4, the conveyance line 3, and the line controller 6 may operate in cooperation with each other. Details of the strength measuring apparatus 4 will be described later.

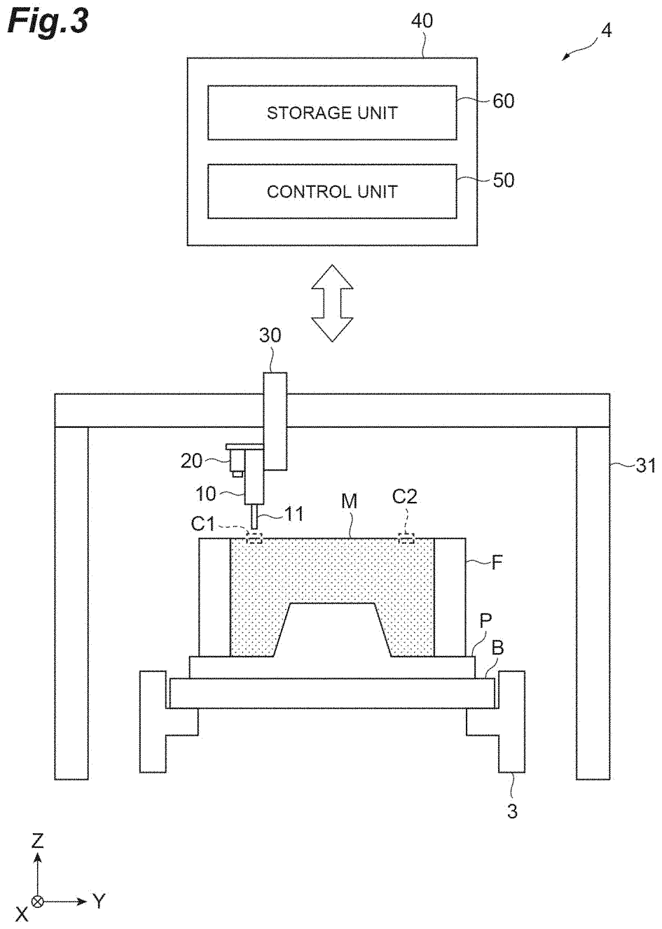

A pattern removing machine W is an apparatus which removes a pattern P (refer to FIG. 3) from the mold M. Removing the pattern P from the mold M means taking the pattern P out of the mold M. A product part to which a product shape is transferred from the pattern P is formed in a location where the pattern P is removed from the mold M. The pattern removing machine W is provided between the molding place 2 and the pouring machine 5. A space into which molten metal flows is defined in the mold M by removing the pattern P from the mold M. The pattern removing machine W may be operated by an operator. The pattern removing machine M may remove the pattern P and the molding flask F from the mold M.

The mold assembly apparatus 7 is an apparatus which mold-assembles a cope and a drag which are paired. The mold assembly apparatus 7 is provided between the pattern removing machine W and the pouring machine 5. The mold assembly apparatus 7 may set a core between the cope and the drag. The mold assembly apparatus 7 may be operated by an operator.

The pouring machine 5 is an apparatus which pours molten metal into the mold M. The pouring machine 5 is communicably connected to the line controller 6. When receiving the flask feeding completion signal from the line controller 6, the pouring machine 5 pours molten metal into the mold M located in a pouring area as a pouring target. The pouring machine 5 receives mold information from the line controller 6 and pours molten metal under a condition based on the mold information. The pouring machine 5 may perform the pouring in accordance with an operation of an operator who stays therein. The mold M with molten metal is conveyed to an area where a downstream process is performed through the conveyance line 3.

The line controller 6 is a controller which performs centralized control of the casting system 1. The line controller 6 is configured as, for example, a programmable logic controller (PLC). The line controller 6 may be configured as a computer system including a processor, such as a central processing unit (CPU), a memory, such as a random access memory (RAM) and a read only memory (ROM), an input/output device, such as a touch panel, a mouse, a keyboard, or a display, and a communication device, such as a network card. The line controller 6 implements the function of the line controller 6 by operating each hardware under control of the processor based on a computer program stored in the memory.

The line controller 6 controls the conveyance line 3 to intermittently convey the molds M with a predetermined standstill time. The standstill time is a time during which the molds M are at a standstill on the conveyance line 3 and previously determined in such a manner that the standstill time and a time during which the molds M move become alternate. For example, the conveyance line 3 conveys the molds M on the driving roller downstream by one flask and brings the molds M to a standstill. After the elapse of the predetermined standstill time, the conveyance line 3 conveys the molds M on the driving roller downstream by one flask and brings the molds M to a standstill. The conveyance line 3 repeatedly performs the conveyance and stopping of the molds M on the basis of the predetermined standstill time.

Details of Strength Measuring Apparatus

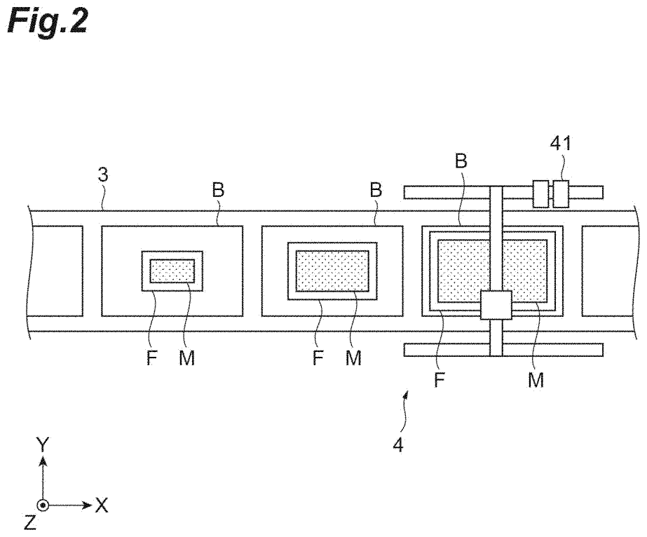

FIGS. 2 and 3 illustrate an example of the strength measuring apparatus according to the embodiment. FIG. 2 is a top view illustrating an example of the strength measuring apparatus according to the embodiment. As illustrated in FIG. 2, the strength measuring apparatus 4 is provided on the conveyance line 3 which conveys the molds M and measures the strength of the molds M on the conveyance line 3. The flasks F and molds M placed on the molding boards B are sequentially carried into the strength measuring apparatus 4. The size of the molding flask F and the size of the mold M depend on the size of a casting product. In the example of FIG. 2, the molding flasks F and molds M having different sizes are conveyed to the strength measuring apparatus 4 through the conveyance line 3. The molding board B on which the molding flask F and the mold M are placed has a size corresponding to the largest molding flask F. The molding flask F and the mold M are positioned in such a manner that the centers of the molding flask F and the mold M substantially coincide with the center of the molding board B and placed on the molding board B.

The strength measuring apparatus 4 may include a positioning unit 41. The positioning unit 41 brings the mold M on the conveyance line 3 to a standstill at a predetermined operation position. The operation position is a position where the strength measuring apparatus 4 measures the strength of the mold M and previously set on the conveyance line corresponding to the disposed position of the strength measuring apparatus 4. The positioning unit 41 is communicably connected to the line controller 6. The line controller 6 brings the conveyance line 3 to a standstill on the basis of the positioning unit 41. For example, the positioning unit 41 includes two proximity switches. The two proximity switches are disposed along the conveyance direction of the conveyance line 3 (X direction). The positioning unit 41 includes, for example, a first proximity switch which is disposed on the upstream side and a second proximity switch which is disposed on the downstream side.

The first proximity switch detects the molding board B, which is conveyed on the conveyance line 3, approaching the first proximity switch. The line controller 6 changes a conveyance speed of the conveyance line 3 to a low speed in response to the first proximity switch detecting the molding board B. The second proximity switch detects the molding board B, which is conveyed on the conveyance line 3, approaching the second proximity switch. The line controller 6 brings the conveyance line 3 to a standstill in response to the second proximity switch detecting the molding board B while the first proximity switch is detecting the molding board B. The positioning unit 41 including the two proximity switches can accurately bring the mold M to a standstill at the operation position by changing the conveyance speed at which the conveyance line 3 conveys the mold M to a low speed and then bringing the conveyance line 3 to a standstill.

FIG. 3 is a sectional view illustrating an example of the strength measuring apparatus according to the embodiment. As illustrated in FIG. 3, the strength measuring apparatus 4 includes a strength measuring instrument 10, a distance sensor 20, a robot 30 (an example of the moving unit), and a control device 40.

The strength measuring instrument 10 includes a measuring unit 11 which comes into contact with the mold M. The strength measuring instrument 10 measures the strength of the mold M on the basis of a reaction force received by the measuring unit 11 from the mold M. The measuring unit 11 is, for example, a needle member. The strength measuring instrument 10 inserts the measuring unit 11 into the mold M to a predetermined depth and measures the reaction force received by the measuring unit 11. The measured reaction force serves as information indicating the strength of the mold M. For example, a reaction force received by the measuring unit 11 from the mold M which has been sufficiently hardened is larger than a reaction force received by the measuring unit 11 from the mold M which has not been sufficiently hardened. The reaction force received from the mold M may be converted into the compressive strength or the mold strength of the mold M.

The distance sensor 20 measures the distance to an object on the conveyance line 3. The distance sensor 20 is a sensor which measures the distance to an object present in a measurement direction. For example, the distance sensor 20 is a laser sensor, an ultrasonic sensor, or a contact sensor. The distance sensor 20 is disposed so as to measure the distance in the height direction (Z direction). That is, the distance sensor 20 is disposed facing the conveyance line 3 above the conveyance line 3. Accordingly, when an object is present under the distance sensor 20, the distance sensor 20 measures the distance to the object in the height direction. When an object is not present under the distance sensor 20, the distance sensor 20 measures the distance to the conveyance line 3 in the height direction.

The robot 30 moves the strength measuring instrument 10 and the distance sensor 20. The robot 30 supports the strength measuring instrument 10 and the distance sensor 20, and moves the strength measuring instrument 10 and the distance sensor 20 along the conveyance direction of the conveyance line 3 (X direction), a horizontal direction perpendicular to the conveyance direction of the conveyance line 3 (Y direction), and the height direction (Z direction). The robot 30 is a three-axis orthogonal robot which integrally moves the strength measuring instrument 10 and the distance sensor 20 in the X direction, the Y direction, and the Z direction. The robot 30 is, for example, supported on a frame 31 and disposed above the conveyance line 3 and the mold M.

The control device 40 is a controller which performs centralized control of the strength measuring apparatus 4. The control device 40 is configured as, for example, a PLC. The control device 40 may be configured as a computer system including a processor, such as a CPU, a memory, such as a RAM and a ROM, an input/output device, such as a touch panel, a mouse, a keyboard, or a display, and a communication device, such as a network card. The control device 40 implements the function of the control device 40 by operating each hardware under control of the processor based on a computer program stored in the memory. The control device 40 may be disposed outside the frame 31 or may be disposed inside the frame 31. The control device 40 is communicably connected to the strength measuring instrument 10, the distance sensor 20, and the robot 30. The control device 40 may be communicably connected to the line controller 6.

The control device 40 includes a control unit 50 and a storage unit 60. The control unit 50 controls the robot 30 to move the strength measuring instrument 10 and the distance sensor 20 in the horizontal direction perpendicular to the conveyance direction of the conveyance line 3 (Y direction). The control unit 50, for example, moves the strength measuring instrument 10 and the distance sensor 20 across the conveyance line 3 from an original position near one of two lateral ends, in the Y direction, of the conveyance line 3 toward the other lateral end. The distance sensor 20 moving in the Y direction continuously measures the distance in the height direction while moving. Consequently, the distance in the height direction can be obtained along the Y direction. The measured distance in the height direction is output from the distance sensor 20 to the control unit 50.

The control unit 50 determines a measurement position C1 of the strength measuring instrument 10 in the Y direction on the basis of the distance detected by the distance sensor 20. The measurement position C1 is a position on the upper face of the mold M where the strength is measured. For example, the control unit 50 recognizes an outer edge position of the object on the conveyance line 3 on the basis of a change in the distance detected by the distance sensor 20. For example, the control unit 50 recognizes, as the outer edge position of the object on the conveyance line 3, a position where the change in the distance in the height direction continuously measured along the Y direction becomes a threshold or more. Alternatively, the control unit 50 may recognize, as the outer edge position of the object, a position in the Y direction where the distance in the height direction becomes a threshold or less. In the example in the drawing, an outer edge position of the molding flask F is recognized as the outer edge position of the object. When the outer edge position of the molding flask F is recognized, the measurement position C1 of the mold M can be appropriately determined. For example, the measurement position C1 can be a position shifted by a predetermined distance from the outer edge position of the molding flask F toward the center of the mold M in the Y direction. The predetermined distance is set to be larger than the known thickness of the molding flask F. The measurement position C1 may be shifted in the X direction when the measurement position C1 interferes with the sprue or the product part of the mold M.

The control unit 50 controls the robot 30 to move the strength measuring instrument 10 and the distance sensor 20 to a position above the measurement position C1. When the control unit 50 detects the above-mentioned outer edge position of the object, the control unit 50 controls the robot 30 to temporarily stop the strength measuring instrument 10 and the distance sensor 20 and then move the strength measuring instrument 10 and the distance sensor 20 to the position above the measurement position C1. When the control unit 50 detects the above-mentioned outer edge position of the object, the control unit 50 may move the strength measuring instrument 10 and the distance sensor 20 to the position above the measurement position C1 without stopping the strength measuring instrument 10 and the distance sensor 20.

The control unit 50 acquires the distance in the height direction detected by the distance sensor 20 above the measurement position C1. Accordingly, the control unit 50 recognizes the distance to the vicinity of the surface of the mold M. The control unit 50 controls the robot 30 to lower the strength measuring instrument 10. The robot 30 inserts the measuring unit 11 provided on the lower part of the strength measuring instrument 10 into the mold M from the surface of the mold M. The strength measuring instrument 10 measures a reaction force received by the measuring unit 11. This enables the strength measuring instrument 10 to measure the strength of the mold M at the measurement position C1. Upon completion of the measurement of the strength measuring instrument 10, the control unit 50 controls the robot 30 to move the strength measuring instrument 10 and the distance sensor 20 to the original position.

In this manner, the control unit 50 not only determines the measurement position C in the Y direction on the basis of the detection result of the distance sensor 20, but also controls the position of the strength measuring instrument 10 in the Z direction on the basis of the detection result of the distance sensor 20. Thus, the control unit 50 can adjust the position of the strength measuring instrument 10 in the Y and Z directions on the basis of the detection result of the single distance sensor.

Moreover, the control unit 50 may determine whether a predetermined step relating to the mold M is performable on the basis of the strength of the mold M measured by the strength measuring instrument 10. The predetermined step is a step performed downstream of the strength measuring apparatus 4 on the conveyance line 3. For example, the control unit 50 compares the strength of the mold M measured by the strength measuring instrument 10 with a threshold to determine whether the predetermined step is performable on the mold M. The threshold is previously set on the basis of the strength of a mold on which the predetermined step has been normally performed. The predetermined step is, for example, a pattern removing step. The pattern removing step is an operation of removing the pattern P from the mold M, the operation being performed by the pattern removing machine W which is provided downstream of the strength measuring apparatus 4 on the conveyance line 3. The mold M having an insufficient strength may be broken by the pattern removing step. When the strength of the mold M is equal to or lower than the threshold, the control unit 50 determines that the pattern removing step is not performable due to the insufficient strength of the mold M.

When it is determined that the pattern removing step relating to the mold M is not performable, the control unit 50 may cause the strength measuring instrument 10 to remeasure the strength of the mold M after the elapse of a predetermined time. Since the self-hardening mold M is hardened with time, a waiting time for hardening is set for the mold M on which the pattern removing step is not performable. The control unit 50 outputs a signal to the line controller 6 to stop the conveyance line 3 until the remeasurement ends. Alternatively, the control unit 50 may output a signal to the line controller 6 to put the mold M on which it is determined that the pattern removing step is not performable standby at a standby place outside the conveyance line 3 and convey the mold M again after the elapse of a predetermined time.

When the remeasurement is performed, the control unit 50 may set the measurement position at a position different from the measurement position C1. This is because, if the strength is remeasured at the measurement position C1 in which the measuring unit 11 has been inserted, the strength measuring instrument 10 may not be able to accurately measure the strength of the mold M. The control unit 50 may set, as a new measurement position, a measurement position C2 symmetric to the measurement position C1 with respect to the center of the mold M. Alternatively, the control unit 50 may set, as a new measurement position, a measurement position shifted in the X direction from the measurement position C1.

The control unit 50 may repeat the setting of the waiting time and the remeasurement a predetermined number of times by controlling the strength measuring instrument 10 until it is determined that the pattern removing step is performable on the mold M. When it is determined that the pattern removing step is performable on the mold M, the control unit 50 outputs a pattern removal enabling signal to the line controller 6. The pattern removal enabling signal is a signal indicating that the pattern removing step is executable. When receiving the pattern removal enabling signal, the line controller 6 conveys the mold M to the pattern removing machine W located on the downstream side. When it is determined after the remeasurement that the pattern removing step is not performable, the control unit 50 may register the mold M as a defective mold.

The storage unit 60 associates the strength measured by the strength measuring instrument 10 with the mold M. The storage unit 60, for example, physically imparts information of the strength measured by the strength measuring instrument 10 to the mold M. The storage unit 60 may impart a radio frequency identifier (RFID) including the information of the strength measured by the strength measuring instrument 10 to the mold M. Alternatively, the storage unit 60 may impart or mark a bar code, a two-dimensional bar code, a number, a character string, or a symbol including the information to or on the mold M. A location to be imparted with the information is not limited to the mold M and may be the pattern P, the molding board B, or the molding flask F. Another piece of information may be associated with the mold M. Examples of the other piece of information include defective information, a serial number of the mold M, a molding time of day, and a molding condition. Examples of the molding condition include the amount of the chemical solution added in the mixing, the kind of the chemical solution, a sand-metal ratio, temperature, humidity, the temperature of sand before mixed, and a molding time.

Operation of Strength Measuring Apparatus

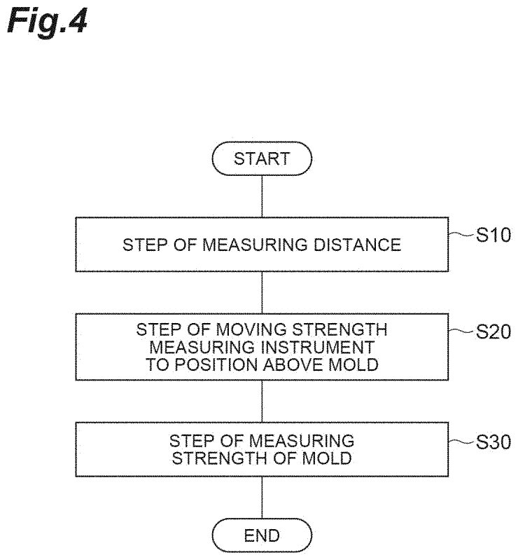

FIG. 4 is a flowchart illustrating an example of an operation of the strength measuring apparatus. The flowchart illustrated in FIG. 4 is started, for example, when the mold M is positioned at the operation position of the strength measuring apparatus 4. First, as a measuring step (step S10), the control unit 50 of the strength measuring apparatus 4 causes the distance sensor 20 to measure the distance in the height direction while controlling the robot 30 to move the strength measuring instrument 10 and the distance sensor 20 in the Y direction.

Next, as a moving step (step S20), the control unit 50 first determines the measurement position C1 of the strength measuring instrument 10 in the Y direction on the basis of the distance detected by the distance sensor 20. For example, the control unit 50 recognizes, as the outer edge position of an object on the conveyance line 3, for example, the position where the change in the distance in the height direction continuously measured along the Y direction becomes the threshold or more. Then, the control unit 50 sets the measurement position C1 at the position shifted by the predetermined distance from the outer edge position toward the center of the mold M in the Y direction. Then, the control unit 50 controls the robot 30 to move the strength measuring instrument 10 and the distance sensor 20 to the position above the measurement position C1.

At last, as a measuring step (step S30), the control unit 50 controls the robot 30 to lower the strength measuring instrument 10. The robot 30 inserts the measuring unit 11 provided on the lower part of the strength measuring instrument 10 into the mold M from the surface of the mold M. The strength measuring instrument 10 measures the reaction force received by the measuring unit 11 as the strength of the mold M. Upon completion of the measurement of the strength measuring instrument 10, the control unit 50 controls the robot 30 to move the strength measuring instrument 10 and the distance sensor 20 to the original position. In this manner, the flowchart illustrated in FIG. 4 ends.

### Summary of Embodiment

According to the strength measuring apparatus 4 and the strength measuring method, the distance to the molding flask F on the conveyance line 3 is measured by the distance sensor 20, and the measurement position C1 of the strength measuring instrument 10 in the Y direction is determined by the control unit 50 on the basis of the measured distance. The strength measuring instrument 10 is moved by the robot 30 to the position above the measurement position C1. Since the measurement position C1 is determined taking into consideration the distance to the molding flask F on the conveyance line 3 in this manner, the strength measuring apparatus 4 and the strength measuring method can measure the strength of the mold M at an appropriate position regardless of the size of the mold M.

According to the strength measuring apparatus 4 and the strength measuring method, since the robot 30 integrally moves the strength measuring instrument 10 and the distance sensor 20, it is not necessary to include a plurality of moving units moving the strength measuring instrument 10 and the distance sensor 20. Moreover, the strength measuring apparatus 4 and the strength measuring method can not only determine the measurement position C1 in the Y direction on the basis of the detection result of the distance sensor 20, but also control the position of the strength measuring instrument 10 in the Z direction on the basis of the detection result of the distance sensor 20. Thus, according to the strength measuring apparatus 4 and the strength measuring method, it is possible to adjust the position of the strength measuring instrument 10 in the Y and Z directions on the basis of the detection result of the single distance sensor.

The strength measuring apparatus 4 and the strength measuring method can measure the strength of the mold M after the positioning unit 41 brings the mold M to a standstill at the predetermined operation position. Thus, the strength measuring apparatus 4 and the strength measuring method can prevent the measuring unit 11 from being mistakenly inserted into the product part or a casting plan part such as the sprue. The strength measuring apparatus 4 and the strength measuring method can determine whether the pattern removing step is performable on the basis of the strength of the mold M and also remeasure the strength of the mold M on which the pattern removing step is not performable after the elapse of the waiting time for hardening. The strength measuring apparatus 4 and the strength measuring method can avoid a case where the mold removing step is performed on the mold M whose strength is not sufficient and a case where the waiting time for hardening is set for the mold M whose strength is already sufficient. That is, it is possible to prevent a pattern removing failure caused by insufficient hardness of the mold M and prevent reduction in production efficiency. The strength measuring apparatus 4 and the strength measuring method can associate a mold M with the strength of the mold M.

### Modifications

Although various explanatory embodiments have been described above, the present invention is not limited to the above explanatory embodiments, and various omissions, replacements, and modifications may be made. In the following description, differences from the above embodiment will be mainly described, and redundant description will be omitted.

The mold M is not limited to a self-hardening mold, and may be, for example, a green sand mold, a gas-hardening mold, or a thermosetting mold.

The strength measuring apparatus 4 may not include the storage unit 60. The storage unit 60 may be provided separately from the control unit 50. The control unit 50 may not stop the conveyance of the mold M when it is determined that the pattern removing step is not performable.

The strength measuring instrument 10 may not include the measuring unit 11 which comes into contact with the mold M. The strength measuring instrument 10 may measure the strength of the mold M on the basis of a test piece acquired from the mold M.

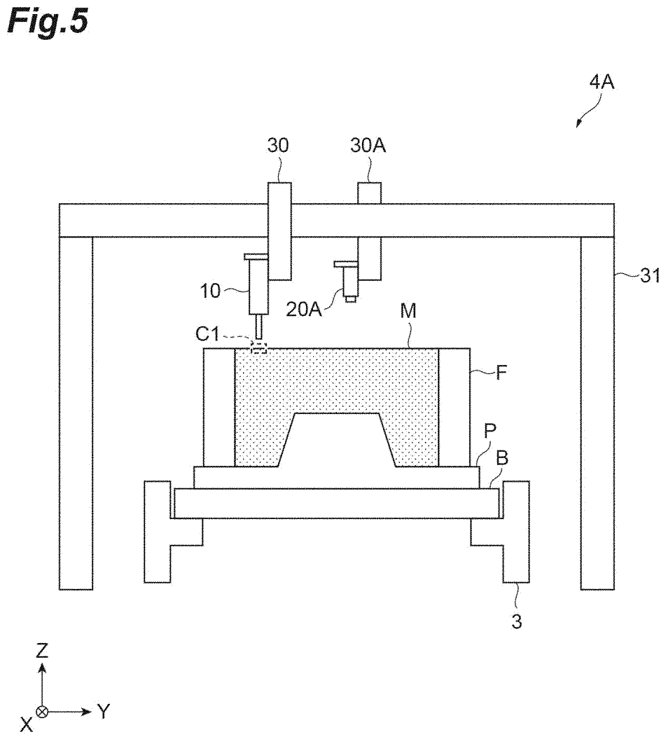

The robot 30 which moves the strength measuring instrument 10 may not move the distance sensor 20. For example, the strength measuring apparatus may further include a sensor moving unit which moves a distance senor in the Y direction. FIG. 5 is a sectional view illustrating an example of a strength measuring apparatus further including a robot which moves a distance sensor in the horizontal direction. As illustrated in FIG. 5, a strength measuring apparatus 4A includes the robot 30 which moves the strength measuring instrument 10 and a robot 30A (an example of the sensor moving unit) which moves a distance sensor 20A. The robot 30A is a three-axis orthogonal robot as with the robot 30. The other configuration of the strength measuring apparatus 4A is the same as that of the strength measuring apparatus 4. The strength measuring apparatus 4A first controls the robot 30A to move the distance sensor 20A in the Y direction to recognize the outer edge position of the molding flask F and determines the measurement position C1. Next, the strength measuring apparatus 4A controls the robot 30 to move the strength measuring instrument 10 to a position above the measurement position C1. The strength measuring apparatus 4A controls the robot 30 on the basis of a detection result of the distance sensor 20A to lower the strength measuring instrument 10 to the vicinity of the surface of the mold M. In this manner, the strength measuring apparatus 4A including the sensor moving means can measure the strength of the mold M at an appropriate position regardless of the size of the mold M.

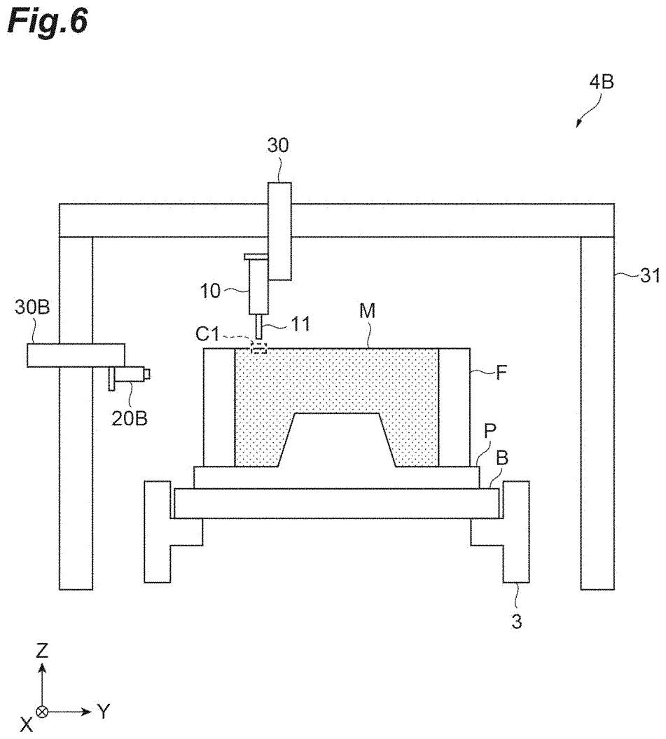

The strength measuring apparatus may further include a sensor moving unit which moves a distance sensor in the Z direction. FIG. 6 is a sectional view illustrating an example of a strength measuring apparatus further including a robot which moves a distance sensor in the vertical direction. As illustrated in FIG. 6, a strength measuring apparatus 4B includes the robot 30 which moves the strength measuring instrument 10 and a robot 30B which moves a distance sensor 20B. The robot 30B is a three-axis orthogonal robot as with the robot 30. The other configuration of the strength measuring apparatus 4B is the same as that of the strength measuring apparatus 4. The strength measuring apparatus 4B first recognizes the outer edge position of an object (molding flask F) on the basis of a detection result of the distance sensor 20B and determines the measurement position C1. Next, the strength measuring apparatus 4B controls the robot 30 to move the strength measuring instrument 10 to a position above the measurement position C1. Then, the strength measuring apparatus 4B controls the robot 30B to move the distance sensor 20B in the Z direction and recognizes, as a height position of the object (the molding flask F and mold M), a location where the distance in the Y direction has changed by a threshold or more. The strength measuring apparatus 4B controls the robot 30 on the basis of the height position of the mold M to lower the strength measuring instrument 10 to the vicinity of the surface of the mold M. In this manner, the strength measuring apparatus 4B including the sensor moving means can measure the strength of the mold M at an appropriate position regardless of the size of the mold M.

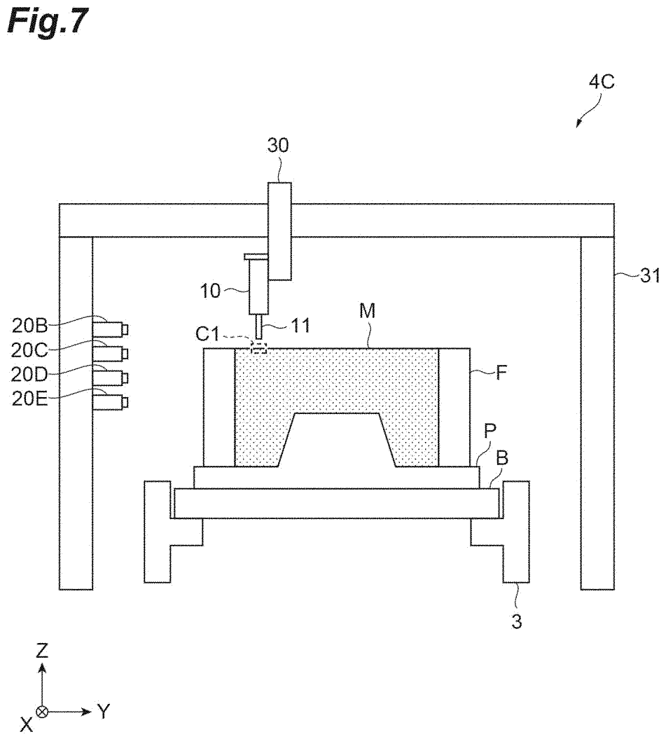

The robot may not move the distance sensor. In this case, the strength measuring apparatus includes a plurality of distance sensors. FIG. 7 is a sectional view illustrating an example of a strength measuring apparatus including a plurality of horizontal-direction distance sensors. As illustrated in FIG. 7, a strength measuring apparatus 4C includes a plurality of distance sensors, namely, a distance sensor 20B, a distance sensor 20C, a distance sensor 20D, and a distance sensor 20E which are disposed in this order from the higher position. These distance sensors measure the distance in the horizontal direction. The other configuration of the strength measuring apparatus 4C is the same as that of the strength measuring apparatus 4B except that the robot does not move the distance sensors. The plurality of distance sensors measures an approximate height of an object (the molding flask F and the mold M) on the conveyance line 3 by measuring the distance in the respective horizontal direction. For example, when the distance in the horizontal direction measured by the distance sensor 20B which is disposed at the highest position is larger than a predetermined value and the distance in the horizontal direction measured by the distance sensors 20C to 20E is smaller than the predetermined value, the height of the mold M is located between the distance sensor 20B and the distance sensor 20C. Further, a detection result of any one of the distance sensors 20C to 20E corresponds to the outer edge position of the object (molding flask F). In this manner, the strength measuring apparatus 4C which does not include the sensor moving means, but includes the plurality of distance sensors can measure the strength of the mold M at an appropriate position regardless of the size of the mold M.

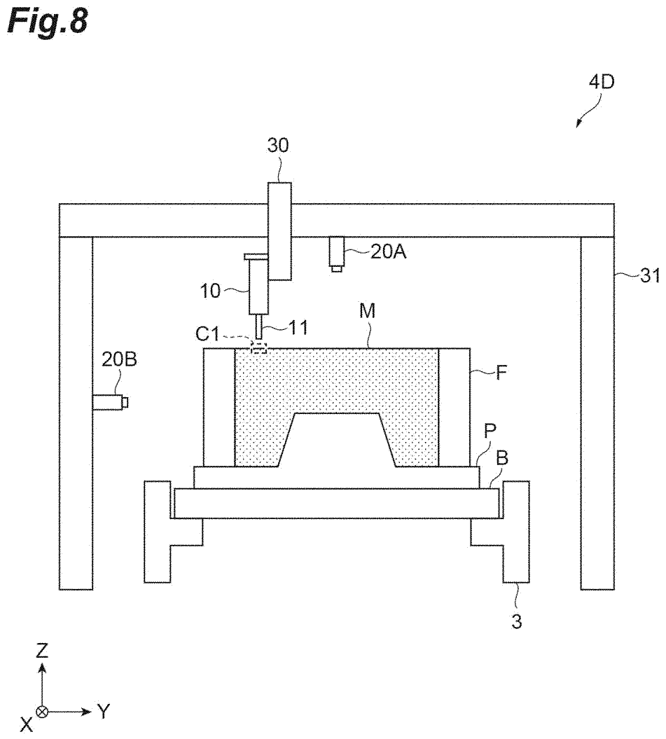

Although, in the example of FIG. 7, the distance sensors are disposed side by side in the height direction, the example of the plurality of distance sensors is not limited to the example of FIG. 7. FIG. 8 is a sectional view illustrating an example of a strength measuring apparatus including a vertical-direction distance sensor and a horizontal-direction distance sensor. As illustrated in FIG. 8, a strength measuring apparatus 4D includes a height-direction distance sensor 20A and a horizontal-direction distance sensor 20B. The other configuration of the strength measuring apparatus 4D is the same as that of the strength measuring apparatus 4C. In the strength measuring apparatus 4D, the outer edge position of an object (molding flask F) is recognized by the distance sensor 20B, and the height distance to the mold M can be acquired by the height-direction distance sensor 20A. Thus, the strength measuring apparatus 4D including the vertical-direction distance sensor and the horizontal-direction distance sensor can measure the strength of the mold M at an appropriate position regardless of the size of the mold M.

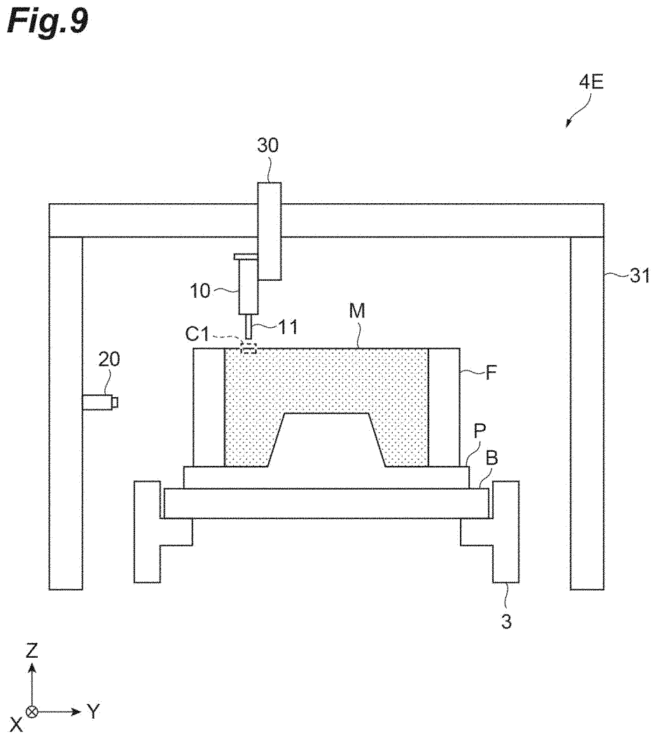

The distance sensor may not measure the height of the mold M. The strength measuring instrument 10 may not bring the measuring unit 11 into contact with the mold M on the basis of the height of the mold M measured by the distance sensor. FIG. 9 is a sectional view illustrating an example of a strength measuring apparatus including one horizontal-direction distance sensor 20. As illustrated in FIG. 9, a strength measuring apparatus 4E includes a horizontal-direction distance sensor 20. The other configuration of the strength measuring apparatus 4E is the same as that of the strength measuring apparatus 4D except that the strength measuring apparatus 4E does not include the height-direction distance sensor 20A. In the strength measuring apparatus 4E, the outer edge position of an object (molding flask F) is recognized by the distance sensor 20, and the measurement position C1 is determined. In a case where the height of the mold M is not measured by a distance sensor, the robot 30 lowers the strength measuring instrument 10 at a low speed until the measuring unit 11 comes into contact with the mold M. When the measuring unit 11 comes into contact with the mold M, the robot 30 stops lowering the strength measuring instrument 10. When the robot 30 stops lowering the strength measuring instrument 10, the strength measuring instrument 10 starts measuring the strength of the mold M. In this manner, the strength measuring apparatus 4E including only the horizontal-direction distance sensor can measure the strength of the mold M at an appropriate position regardless of the size of the mold M.

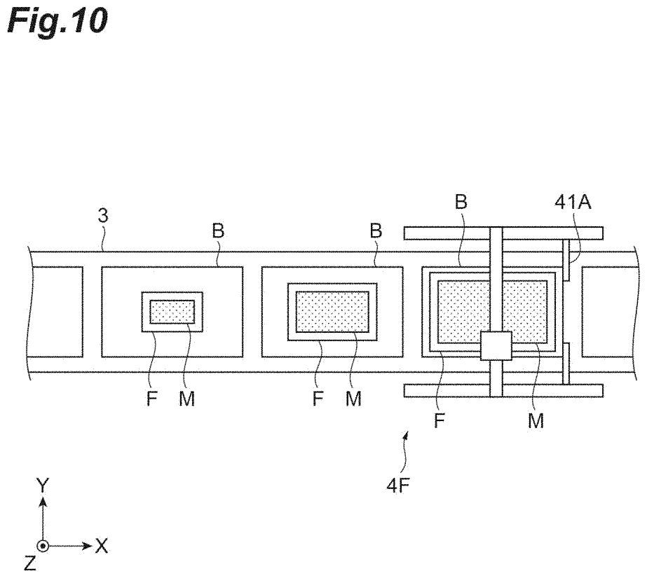

FIG. 10 is a top view of a strength measuring apparatus including another positioning unit. As illustrated in FIG. 10, a strength measuring apparatus 4F differs from the strength measuring apparatus 4 in that a positioning unit 41A is provided instead of the positioning unit 41, but is otherwise the same. The positioning unit 41A mechanically brings the mold M on the conveyance line 3 to a standstill at a predetermined operation position. For example, the positioning unit 41A is configured as a stopper which mechanically comes into contact with the molding board B. The stopper projects to the conveyance line 3 and comes into contact with the molding board B in such a manner as to face the molding board B in the conveyance direction thereof. The stopper projects to the conveyance line 3 in the vertical direction, in the horizontal direction, or in such a manner as to turn. When the projecting stopper comes into contact with the molding board B, the line controller 6 brings the conveyance line 3 to a standstill. When the strength measuring instrument 10 finishes the measurement of the strength of the mold M, the contact between the stopper and the molding board B is released. After the contact between the stopper and the molding board B is released, the mold M is conveyed by the conveyance line 3. The stopper may be a pin (or a bush) (not illustrated) which is engageable with a bush (or a pin) provided on the molding board B.

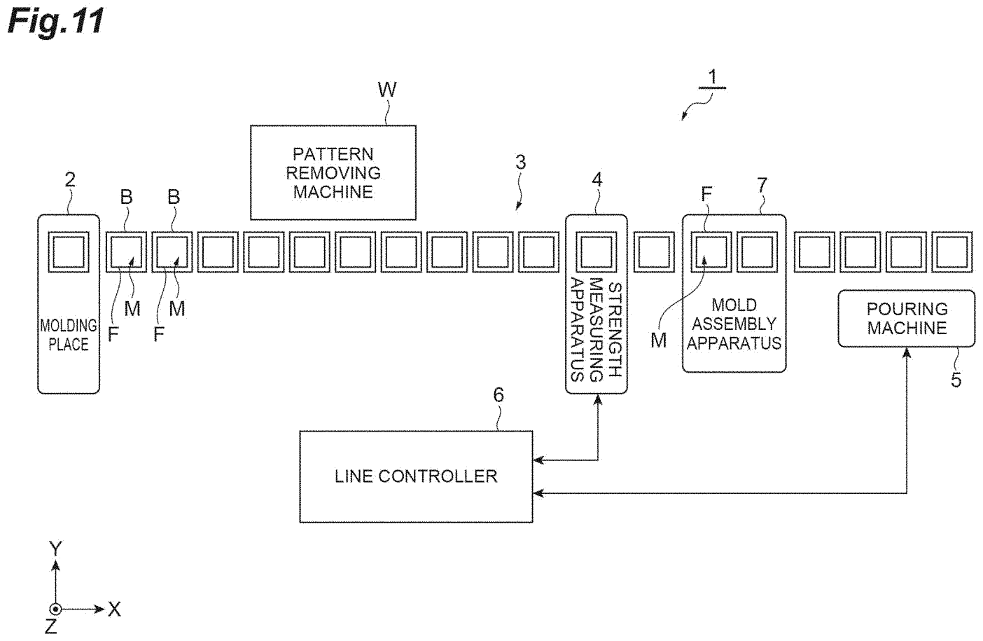

The strength measuring apparatus is not limited to the apparatus which determines whether the pattern removing step is performable. For example, the strength measuring apparatus may determine whether a pouring step is performable. FIG. 11 is a configuration diagram illustrating another example of the casting system 1 (a part of the casting system) including the strength measuring apparatus 4 located upstream of the pouring machine 5. As illustrated in FIG. 11, the strength measuring apparatus 4 is disposed downstream of the pattern removing machine W and upstream of the pouring machine 5 on the conveyance line 3. The control unit 50 determines whether the pouring step is performable on the basis of the strength. When the strength of the mold M is insufficient, there is a possibility that the product cannot be manufactured. When the strength of the mold M is equal to or less than a threshold, the control unit 50 determines that the pouring step is not performable. In this case, the control unit 50 may keep the mold M at a standstill and cause the strength measuring instrument 10 to measure the strength of the mold M after the elapse of a predetermined time as with the determination as to whether the pattern removing step is performable.

The robot described above is not limited to the orthogonal robot. The robot may be, for example, a robot for movement in the direction of one axis or the directions of two axes, or may be a multi-articulated robot, a parallel-link robot, or a SCARA robot.

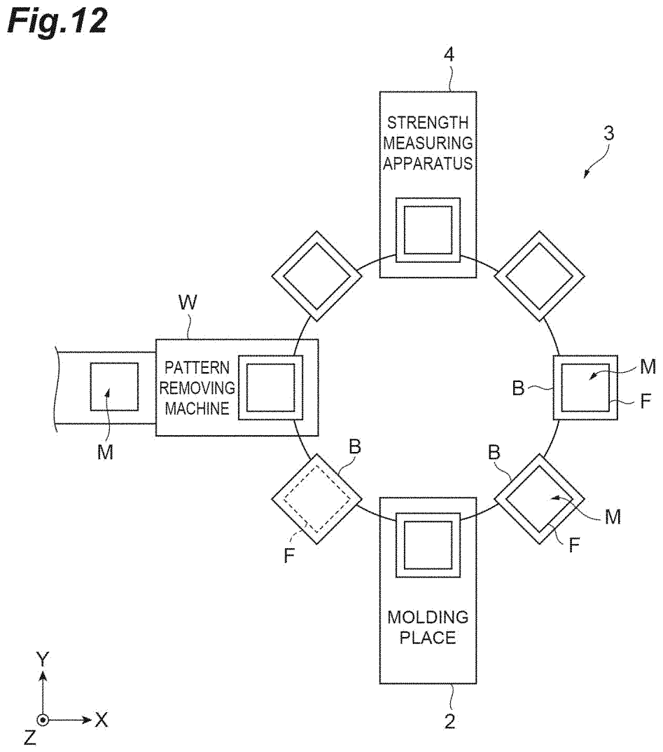

FIG. 12 is a configuration diagram illustrating an example of a conveyance line 3 which annularly conveys the molds M. In this case, the conveyance line 3 is configured as, for example, a turntable. In the following description, differences from FIG. 1 will be mainly described, and redundant description will be omitted. The turntable is a conveyance apparatus having a disc-like shape and rotates in the counterclockwise direction about the center of the disc serving as a rotation axis. The molding board B, the pattern P, the molding flask F, and the mold M which are placed on the turntable are conveyed through the rotation of the turntable. The turntable is intermittently driven and rotates in such a manner as to convey the molds M by a predetermined number of flasks at each drive.

The molding place 2, the strength measuring apparatus 4, and the pattern removing machine W are disposed at respective positions corresponding to the molding board B, the pattern P, the molding flask F, and the mold M which are conveyed on the turntable. For example, the molding place 2, the strength measuring apparatus 4, and the pattern removing machine W may be disposed on the periphery of the turntable. In this case, a cylinder (not illustrated) which pushes out the molding board B, the pattern P, the molding flask F, and the mold M to the periphery of the turntable may be provided on the center of the turntable.

In the molding place 2, mixed sand is charged into the molding flask F and the pattern P which are placed on the molding board B to manufacture the mold M. The mold M manufactured in the molding place 2 is fed to the turntable. In the following, description will be made assuming that the position where the molding place 2 for manufacturing the mold M is disposed is the most upstream conveyance position of the turntable.

The strength measuring apparatus 4 is disposed downstream of the molding place 2. The strength measuring apparatus 4 is located in the counterclockwise circumferential direction when viewed from the molding place 2. The strength measuring apparatus 4 includes a horizontal-direction distance sensor 20 (e.g., refer to FIG. 9) which is disposed facing the turntable in the radial direction thereof. The outer edge position of an object (molding flask F) corresponding to the mold M conveyed from the molding place 2 is recognized by the distance sensor 20, and the measurement position C1 is determined. In the case where the mold M is pushed out by the cylinder to the periphery of the turntable, the horizontal-direction distance sensor 20 may be disposed perpendicular to the direction in which the mold M is pushed out. The mold M whose strength has been measured by the strength measuring apparatus 4 is fed to the turntable.

The pattern removing machine W is disposed downstream of the strength measuring apparatus 4. The pattern removing machine W removes the pattern P and the molding flask F from the mold M carried thereinto. The mold M separated from the pattern P and the molding flask F is carried out of the turntable. The pattern P and the molding flask F are placed on the molding board B and carried out to the turntable again. The pattern P and the molding flask F carried out of the pattern removing machine W are carried into the molding place 2 again.

As described above, also in the case where the molds M are annularly conveyed as illustrated in FIG. 12, the strength measuring apparatus 4 and the strength measuring method can determine whether the pattern removing step is performable on the basis of the strength of the mold M and remeasure the strength of the mold M on which the pattern removing step is not performable after the waiting time for hardening.

### REFERENCE SIGNS LIST

1 . . . casting system, 2 . . . molding place, 3 . . . conveyance line, 4 . . . strength measuring apparatus, 5 . . . pouring machine, 6 . . . line controller, M . . . mold, F . . . molding flask, B . . . molding board, P . . . pattern, 10 . . . strength measuring instrument, 11 . . . measuring unit, 20, 20A, 20B, 20C, 20D, 20E . . . distance sensor, 30, 30A, 30B . . . robot, 40 . . . control device, 41, 41A . . . positioning unit, 50 . . . control unit, 60 . . . storage unit.

What is claimed is:

1. A strength measuring apparatus provided on a conveyance line conveying a mold, the strength measuring apparatus measuring a strength of the mold on the conveyance line and comprising:
a strength measuring instrument configured to measure the strength of the mold on the basis of a reaction force received from the mold;
a moving unit configured to move the strength measuring instrument;
a distance sensor configured to measure a distance to an object on the conveyance line; and
a control unit configured to control the moving unit, wherein
the control unit determines a measurement position of the strength measuring instrument in a horizontal direction perpendicular to a conveyance direction of the conveyance line on the basis of the distance detected by the distance sensor and controls the moving unit to move the strength measuring instrument to a position above the measurement position.

2. The strength measuring apparatus according to claim 1, wherein
the distance sensor is disposed so as to measure a distance in a height direction,
the strength measuring apparatus further comprises a sensor moving unit configured to move the distance sensor in the horizontal direction perpendicular to the conveyance line, and
the control unit recognizes an outer edge position of the object on the conveyance line on the basis of a change in the distance detected by the distance sensor and determines the measurement position on the basis of the outer edge position.

3. The strength measuring apparatus according to claim 1, wherein
the distance sensor is disposed so as to measure a distance in a height direction,
the moving unit moves the distance sensor together with the strength measuring instrument in the horizontal direction perpendicular to the conveyance line, and
the control unit recognizes an outer edge position of the object on the conveyance line on the basis of a change in the distance detected by the distance sensor and determines the measurement position on the basis of the outer edge position.

4. The strength measuring apparatus according to claim 1, wherein the distance sensor is disposed so as to measure a distance in the horizontal direction perpendicular to the conveyance direction of the conveyance line.

5. The strength measuring apparatus according to claim 1, further comprising a positioning unit configured to bring the mold on the conveyance line to a standstill at a predetermined operation position.

6. The strength measuring apparatus according to claim 2, further comprising a positioning unit configured to bring the mold on the conveyance line to a standstill at a predetermined operation position.

7. The strength measuring apparatus according to claim 3, further comprising a positioning unit configured to bring the mold on the conveyance line to a standstill at a predetermined operation position.

8. The strength measuring apparatus according to claim 4, further comprising a positioning unit configured to bring the mold on the conveyance line to a standstill at a predetermined operation position.

9. The strength measuring apparatus according to claim 1, wherein the control unit determines whether a predetermined step relating to the mold is performable on the basis of the strength of the mold measured by the strength measuring instrument.

10. The strength measuring apparatus according to claim 2, wherein the control unit determines whether a predetermined step relating to the mold is performable on the basis of the strength of the mold measured by the strength measuring instrument.

11. The strength measuring apparatus according to claim 3, wherein the control unit determines whether a predetermined step relating to the mold is performable on the basis of the strength of the mold measured by the strength measuring instrument.

12. The strength measuring apparatus according to claim 4, wherein the control unit determines whether a predetermined step relating to the mold is performable on the basis of the strength of the mold measured by the strength measuring instrument.

13. The strength measuring apparatus according to claim 5, wherein the control unit determines whether a predetermined step relating to the mold is performable on the basis of the strength of the mold measured by the strength measuring instrument.

14. The strength measuring apparatus according to claim 6, wherein the control unit determines whether a predetermined step relating to the mold is performable on the basis of the strength of the mold measured by the strength measuring instrument.

15. The strength measuring apparatus according to claim 7, wherein the control unit determines whether a predetermined step relating to the mold is performable on the basis of the strength of the mold measured by the strength measuring instrument.

16. The strength measuring apparatus according to claim 8, wherein the control unit determines whether a predetermined step relating to the mold is performable on the basis of the strength of the mold measured by the strength measuring instrument.

17. The strength measuring apparatus according to claim 9, wherein
the predetermined step is a pattern removing step,
the control unit outputs a pattern removal enabling signal when it is determined that the pattern removing step relating to the mold is performable, and
the strength measuring instrument remeasures the strength of the mold after an elapse of a predetermined time when it is determined that the pattern removing step relating to the mold is not performable.

18. The strength measuring apparatus according to claim 10, wherein
the predetermined step is a pattern removing step,
the control unit outputs a pattern removal enabling signal when it is determined that the pattern removing step relating to the mold is performable, and
the strength measuring instrument remeasures the strength of the mold after an elapse of a predetermined time when it is determined that the pattern removing step relating to the mold is not performable.

19. The strength measuring apparatus according to claim 1, further comprising a storage unit configured to associate the strength of the mold measured by the strength measuring instrument with the mold.

20. A strength measuring method for measuring a strength of a mold on a conveyance line using a strength measuring instrument, the method comprising:
measuring, using a distance sensor, a distance to an object on the conveyance line;
determining a measurement position of the strength measuring instrument in a horizontal direction perpendicular to a conveyance direction of the conveyance line on the basis of the distance detected by the distance sensor and moving the strength measuring instrument to a position above the measurement position; and
measuring, using the strength measuring instrument, the strength of the mold at the measurement position.
